(19) United States
(12) Patent Application Publication
(10) Pub. No.: US 2026/0011875 A1
(43) Pub. Date: Jan. 8, 2026

(54) BUSBAR MODULE

(71) Applicant: Yazaki Corporation, Tokyo (JP)

(72) Inventor: Hidehiko Shimizu, Makinohara-shi (JP)

(21) Appl. No.: 19/225,549

(22) Filed: Jun. 2, 2025

(30) Foreign Application Priority Data
Jul. 3, 2024 (JP) 2024-107382

(51) Int. Cl. H01M 50/507; H01M 50/519; H01M 50/583

(52) U.S. Cl. CPC H01M 50/507; H01M 50/519; H01M 50/583

(57) ABSTRACT

A busbar module includes a plurality of busbars connected to an electrodes of a battery, and a circuit board including a conductive pattern connected to a busbar, and an insulating sheath covering the conductive pattern. The insulating sheath includes a sheath body and a sheath branch portion protruding from the sheath body. The conductive pattern includes a conductive pattern body covered with the sheath body and provided along a longitudinal direction of the sheath body, and a conductive pattern branch portion covered with the sheath branch portion. The busbar is connected to a distal end of the conductive pattern branch portion, and a pattern fuse is provided on the conductive pattern branch portion.

### CROSS-REFERENCE TO RELATED APPLICATIONS

This application is based on and claims priority under 35 USC 119 from Japanese Patent Application No. 2024-107382 filed on Jul. 3, 2024, the contents of which are incorporated herein by reference.

### TECHNICAL FIELD

The present disclosure relates to a busbar module.

### BACKGROUND ART

In the related art, a busbar module for connecting a plurality of batteries in series or in parallel in an automobile is known (for example, see Patent Literature 1).

### CITATION LIST

### Patent Literature

Patent Literature 1: JP2023-161743A

### SUMMARY OF INVENTION

FIG. 3 shows an example of a busbar module 3 in the related art. The busbar module 3 includes a plurality of busbars 33 connected in series or in parallel to electrodes 32 of a plurality of batteries 31, and a circuit board 36 including a plurality of conductive patterns 34 each connected to a respective one of the plurality of busbars 33 and an insulating sheath 35 covering the plurality of conductive patterns 34. The circuit board 36 is a flexible printed circuit (FPC) having flexibility. The insulating sheath 35 includes an elongated sheath body 37 and a plurality of sheath branch portions 38 protruding from the sheath body 37 in the lateral direction. Each of the plurality of conductive patterns 34 includes a conductive pattern body 39 covered with the sheath body 37 and provided along the longitudinal direction of the sheath body 37, and a conductive pattern branch portion 40 covered with the sheath branch portion 38. The busbar 33 is connected to the distal end of the conductive pattern branch portion 40. In this busbar module 3, a pattern fuse 41 having a reduced width dimension is provided in a part of the conductive pattern body 39.

In the busbar module 3, since the pattern fuse 41 is provided in a part of the conductive pattern body 39, when the pattern fuse 41 is fused, the conductive pattern body 39 may be damaged depending on the degree of fusing.

The present disclosure has been made in view of the above circumstances, and an object of the present disclosure is to provide a busbar module in which even when a pattern fuse is fused, damage does not expand to other portions.

In order to achieve the object described above, a busbar module according to the present disclosure is characterized as follows.

The busbar module of the present disclosure includes a plurality of busbars connected to electrodes of a plurality of batteries, and a circuit board including a plurality of conductive patterns each connected to a respective one of the plurality of busbars, and an insulating sheath covering the plurality of conductive patterns. The insulating sheath includes an elongated sheath body and a plurality of sheath branch portions protruding from the sheath body in a lateral direction. Each of the plurality of conductive patterns includes a conductive pattern body covered with the sheath body and provided along a longitudinal direction of the sheath body, and a conductive pattern branch portion covered with the sheath branch portion. The busbar is connected to a distal end of the conductive pattern branch portion, and a pattern fuse is provided on the conductive pattern branch portion.

According to the busbar module in the present disclosure, an effect is attained that even when the pattern fuse is fused, damage does not expand to other portions.

The present disclosure has been briefly described above. Further, the details of the present disclosure can be clarified by reading a mode (hereinafter, referred to as an “embodiment”) for carrying out the invention to be described below with reference to the accompanying drawings.

### BRIEF DESCRIPTION OF DRAWINGS

FIG. 1 is a partial plan view of a busbar module according to a first embodiment of the present disclosure;

FIG. 2 is a perspective view showing a sheath body;

FIG. 3 is a perspective view showing a sheath branch portion;

FIG. 4 is a partial plan view of a busbar module according to a second embodiment of the present disclosure; and

FIG. 5 is a partial plan view of a busbar module in the related art.

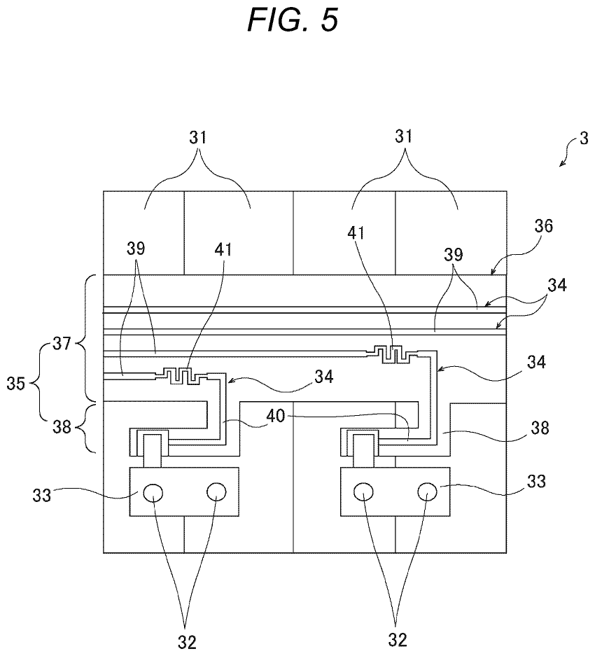

### DESCRIPTION OF EMBODIMENTS

Specific embodiments of the present disclosure will be described below with reference to the drawings.

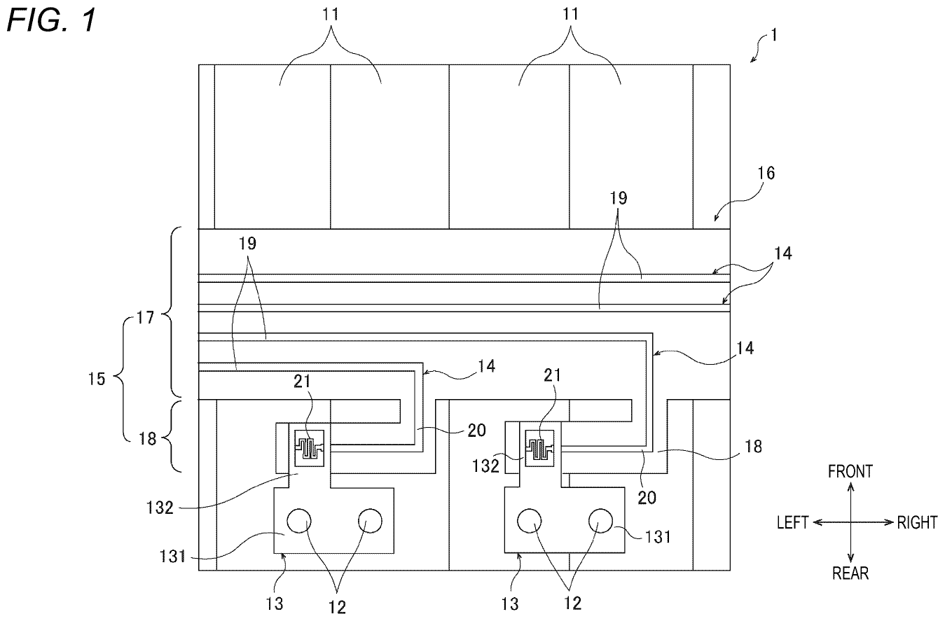

Hereinafter, for convenience of description, as shown in FIGS. 1 to 4, “front”, “rear”, “left”, “right”, “upper”, and “lower” are defined. The “front-rear direction”, the “left-right direction”, and the “upper-lower direction” are orthogonal to one another. The “left-right direction” corresponds to the “longitudinal direction” according to the present disclosure, and the “front-rear direction” corresponds to the “lateral direction” according to the present disclosure.

### First Embodiment

Hereinafter, a busbar module according to a first embodiment of the present disclosure will be described with reference to the drawings. A busbar module 1 shown in FIG. 1 is provided on the upper face of a plurality of batteries 11, connects the plurality of batteries 11 in series, and supplies a voltage across the plurality of batteries 11 to a battery monitoring device (not shown). The plurality of batteries 11 are arranged side by side in the left-right direction. A pair of electrodes 12 protrude from the upper face of the batteries 11. The pair of electrodes 12 are arranged side by side in the front-rear direction. In the partial plan view of FIG. 1, only the rear electrode 12 is shown.

As shown in FIG. 1, the busbar module 1 includes a plurality of busbars 13 connected to the electrodes 12 of the plurality of batteries 11, and a circuit board 16 including a plurality of conductive patterns 14 each connected to a respective one of the plurality of busbars 13 and an insulating sheath 15 covering the plurality of conductive patterns 14. The circuit board 16 is a flexible printed circuit (FPC) having flexibility.

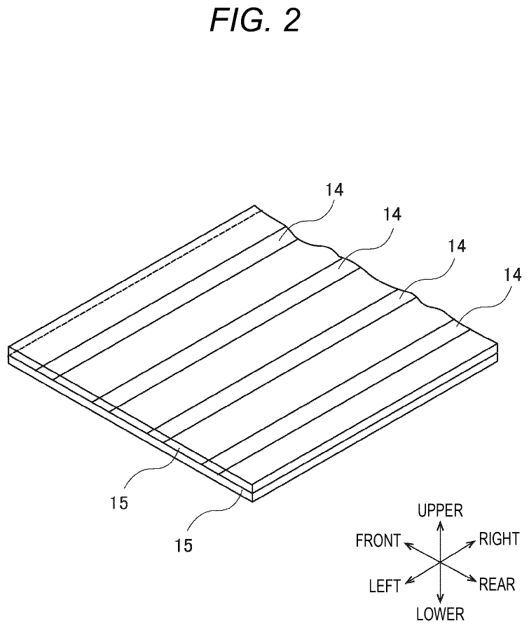

As shown in FIG. 2, a pair of insulating sheaths 15 are provided, and the pair of insulating sheaths 15 and 15 sandwich the conductive pattern 14 in the upper-lower direction (the thickness direction). As shown in FIG. 1, the pair of insulating sheaths 15 and 15 include a sheath body 17 elongated in the left-right direction and a plurality of sheath branch portions 18 protruding rearward (in the lateral direction) from the sheath body 17.

Each of the plurality of conductive patterns 14 includes a conductive pattern body 19 covered with the sheath body 17 and provided along the longitudinal direction of the sheath body 17, and a conductive pattern branch portion 20 covered with the sheath branch portion 18. The conductive pattern bodies 19 are arranged side by side in the front-rear direction. The left end portion of the conductive pattern body 19 described above is connected to the battery monitoring device. The conductive pattern branch portion 20 protrudes rearward from the right end of the conductive pattern body 19. A pattern fuse 21 is provided on the conductive pattern branch portion 20. The pattern fuse 21 has a width dimension smaller than that of the conductive pattern branch portion 20 and is formed in a labyrinth shape.

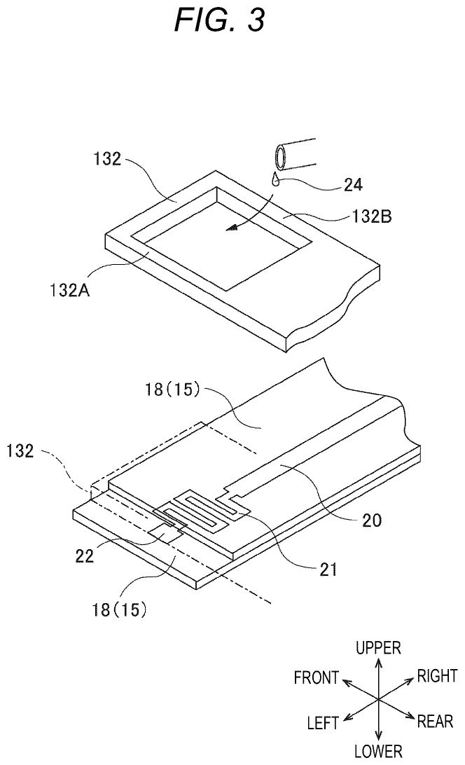

As shown in FIG. 3, a conductive pad 22 in contact with the busbar 13 is provided at the distal end of the conductive pattern branch portion 20. Then, the upper sheath branch portion 18 is peeled off from the lower sheath branch portion 18 such that the conductive pad 22 is exposed.

Next, the busbar 13 will be described. The busbar 13 is provided by punching and bending a metal plate. As shown in FIG. 1, the busbar 13 includes an electrode connection portion 131 (a first connection portion) connected to the electrode 12 and a pad connection portion 132 (a second connection portion, a metal plate) connected to the conductive pad 22. The electrode connection portion 131 is formed with a pair of electrode insertion holes into which the electrodes 12 of the batteries 11 adjacent in the left-right direction are inserted. The pad connection portion 131 protrudes forward from the electrode connection portion 132.

The pad connection portion 132 has a frame shape opened in a rectangular shape. As shown in FIG. 3, in this pad connection portion 132, a vertical frame 132A is in contact with the conductive pad 22, and a vertical frame 132B is placed on the upper sheath branch portion 18. Accordingly, the pad connection portion 132 is electrically connected to the conductive pattern branch portion 20 via a vertical frame 132A and the conductive pad 22, and surrounds the pattern fuse 21. The opening of the pad connection portion 132 is filled with a resin 24. The resin 24 has insulating properties and thermal conductivity.

### Operations and Effects of First Embodiment

As described above, according to the busbar module 1 in the embodiment of the present disclosure, since the pattern fuse 21 is provided on the conductive pattern branch portion 20, even if the pattern fuse 21 is fused, damage does not expand to other portions. According to the busbar module 1, since the pad connection portion 132 surrounding the pattern fuse 21 is provided, when the pattern fuse 21 is fused, the sheath branch portion 18 does not melt and the fire does not spread beyond the pad connection portion 132. Further, according to the busbar module 1, even if the pattern fuse 21 generates heat, the heat can be dissipated via the pad connection portion 132.

Further, according to the busbar module 1, since the pad connection portion 132 is filled with the resin 24, even when the pattern fuse 21 is fused, melted fragments do not scatter, and there is no risk of a short circuit or the like. In particular, according to the busbar module 1, the resin 24 has thermal conductivity, and thus operates together with the pad connection portion 132 to provide a good cooling effect. Further, according to the busbar module 1, the metal plate surrounding the pattern fuse 21 is implemented by the pad connection portion 132. Therefore, it is not necessary to separately provide the metal plate and the busbar 13, and the cost can be reduced.

### Second Embodiment

Next, a busbar module according to a second embodiment of the present disclosure will be described. In the second embodiment to be described below, the members already described in the first embodiment are denoted by the same reference signs in the drawings, and accordingly the description thereof will be simplified or omitted.

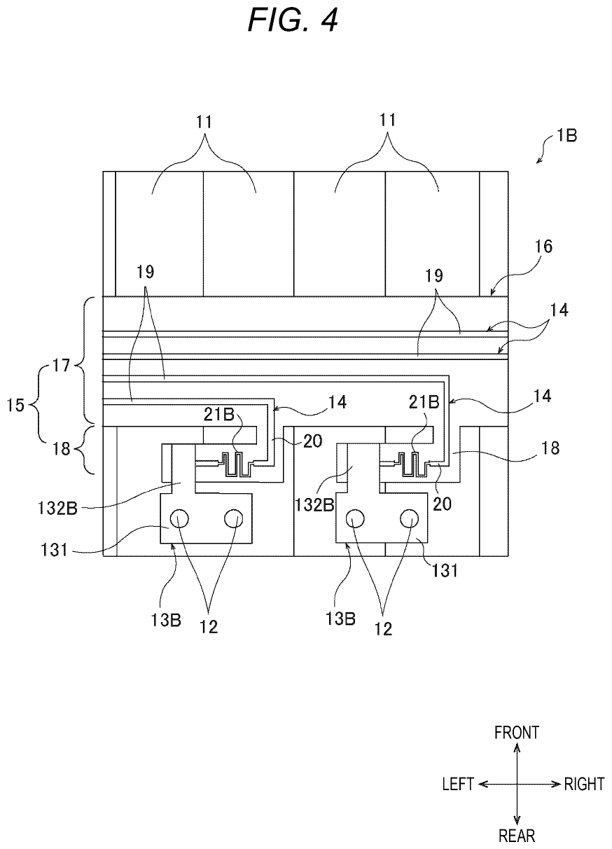

As shown in FIG. 4, a busbar module 1B according to the second embodiment of the present disclosure is different from the first embodiment in the shape of a busbar 13B. In the second embodiment, the busbar 13B includes the electrode connection portion 131 similar to that of the first embodiment and a pad connection portion 132B. The pad connection portion 132B according to the second embodiment is provided in a flat plate shape and does not surround a pattern fuse 21B. The pattern fuse 21B according to the second embodiment is provided apart from the conductive pad 22. As in the first embodiment, the upper sheath branch portion 18 is peeled off from the lower sheath branch portion 18 such that the conductive pad 22 is exposed. The pad connection portion 133 overlaps and is connected onto the exposed conductive pad 22.

### Operations and Effects of Second Embodiment

As described above, according to the busbar module 1B in the embodiment of the present disclosure, since the pattern fuse 21B is provided on the conductive pattern branch portion 20, even if the pattern fuse 21B is fused, damage does not expand to other portions.

The present disclosure is not limited to the embodiments described above and can be appropriately modified, improved and the like. In addition, the materials, shapes, sizes, numbers, arrangement positions, and the like of the components in the embodiments described above are freely selected and are not limited as long as the present disclosure can be implemented.

In the first embodiment described above, the pattern fuse 21 is surrounded by the pad connection portion 132 of the busbar 13, but the present disclosure is not limited thereto. A metal plate different from the busbar 13 may be used to surround the pattern fuse 21.

Here, the features of the embodiments described above of the busbar module according to the present disclosure will be briefly summarized and listed in the following [1] to [4].

[1] A busbar module (1) including:
a plurality of busbars (13) connected to electrodes (12) of a plurality of batteries (11); and
a circuit board (16) including a plurality of conductive patterns (14) each connected to a respective one of the plurality of busbars (13), and an insulating sheath (15) covering the plurality of conductive patterns (14),
in which the insulating sheath (15) includes an elongated sheath body (17) and a plurality of sheath branch portions (18) protruding from the sheath body (17) in a lateral direction,
in which each of the plurality of conductive patterns (14) includes a conductive pattern body (19) covered with the sheath body (17) and provided along a longitudinal direction of the sheath body (17), and a conductive pattern branch portion (20) covered with the sheath branch portion (18),
in which the busbar (13) is connected to a distal end of the conductive pattern branch portion (20), and
in which a pattern fuse (21) is provided on the conductive pattern branch portion (20).

According to the busbar module (1) having the configuration in the above [1], since the pattern fuse (21) is provided on the conductive pattern branch portion (20), even if the pattern fuse (21) is fused, damage does not expand to other portions.

[2] The busbar module (1) according to the above [1], further including
a metal plate (132) surrounding the pattern fuse (21).

According to the busbar module (1) having the configuration in the above [2], since the metal plate (132) surrounding the pattern fuse (21) is provided, when the pattern fuse (21) is fused, the upper sheath branch portion (18A) and the lower sheath branch portion (18B) do not melt and the fire does not spread beyond the metal plate (132). Further, according to the busbar module (1), even if the pattern fuse (21) generates heat, the heat can be dissipated via the metal plate (132).

[3] The busbar module according to the above [2],
in which the metal plate (132) is filled with a resin (24).

According to the busbar module (1) having the configuration in the above [3], since the metal plate (132) is filled with the resin (24), even when the pattern fuse (21) is fused, melted fragments do not scatter, and there is no risk of a short circuit or the like. In particular, according to the busbar module (1), the resin (24) has thermal conductivity, and thus operates together with the metal plate (132) to provide a good cooling effect.

[4] The busbar module (1) according to the above [2],
in which the busbar (13) includes a first connection portion (131) connected to the electrode (12) and a second connection portion (132) connected to the conductive pattern (14),and
in which the metal plate is implemented by the second connection portion (132).

According to the busbar module (1) having the configuration in the above [4], it is not necessary to separately provide the metal plate (132) and the busbar (13), and the cost can be reduced.

What is claimed is:

1. A busbar module comprising:
a plurality of busbars connected to electrodes of a plurality of batteries; and
a circuit board including a plurality of conductive patterns each connected to a respective one of the plurality of busbars, and an insulating sheath covering the plurality of conductive patterns,
wherein the insulating sheath includes an elongated sheath body and a plurality of sheath branch portions protruding from the sheath body in a lateral direction,
wherein each of the plurality of conductive patterns includes a conductive pattern body covered with the sheath body and provided along a longitudinal direction of the sheath body, and a conductive pattern branch portion covered with the sheath branch portion,
wherein the busbar is connected to a distal end of the conductive pattern branch portion, and
wherein a pattern fuse is provided on the conductive pattern branch portion.

2. The busbar module according to claim 1, further comprising
a metal plate surrounding the pattern fuse.

3. The busbar module according to claim 2,
wherein the metal plate is filled with a resin.

4. The busbar module according to claim 2,
wherein the busbar includes a first connection portion connected to the electrode and a second connection portion connected to the conductive pattern, and
wherein the metal plate is implemented by the second connection portion.
